(19) United States
(12) Patent Application Publication
(10) Pub. No.: US 2007/0169671 A1
(43) Pub. Date: Jul. 26, 2007

(54) Mold Inhibiting Admixture for a Cementitious Material

(76) Inventor: Daniel P. Johnston, Pierre, SD (US)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 11/624,940

(22) Filed: Jan. 19, 2007

Related U.S. Application Data
(60) Provisional application No. 60/761,126, filed on Jan. 23, 2006.

(51) Int. Cl. C09D 5/14; C04B 24/00; C04B 14/00

(52) U.S. Cl. 106/810; 106/15.05; 106/728

(57) ABSTRACT

An admixture for a cementitious mixture to inhibit mold growth on the surface of a cementitious material, such as a concrete block or a revetment. The admixture includes a water soluble alkali or alkaline earth salt of an alkyl, alkenyl, aryl, alkaryl, or alkenaryl carboxylic acid.

### RELATED APPLICATIONS

This application claims the benefit of Provisional Application Ser. No. 60/761,126, filed Jan. 23, 2006, the entire disclosure of which is incorporated herein by reference.

### TECHNICAL FIELD

The invention generally relates to cementitious materials. More particularly, the invention pertains to cementitious materials having mold inhibiting properties.

### BACKGROUND

Egyptians first began to use concrete in around 2,500 BC, and the Romans first constructed buildings of concrete in around 300 BC. Developments in concrete technology since the first uses in Egypt have resulted in numerous compositions, uses, and facets, with maybe the most noted development occurring in 1824, when Joseph Aspdin devised a complex mix of many compounds now commonly referred to as portland cement.

Today, concrete, which is the second-most used substance on the Earth, is the most used man-made material in the world, water being the only substance used more. It has been estimated that over six billion tons of concrete are made each year throughout the world. Therefore, it may be valuable to devise further advances in concrete technology.

### SUMMARY

The invention is directed to cementitious materials having mold inhibiting properties.

Accordingly, one embodiment is a cementitious material including a cementitious mixture and an admixture having an effective amount of a solution of an alkali, alkaline earth or ammonium salt of an alkyl, alkenyl, aryl, alkaryl, or alkenaryl carboxylic acid to inhibit mold growth. Furthermore, one embodiment is a cementitious material including a cementitous mixture and an admixture including a water soluble alkali, alkaline earth or ammonium salt derived from a carboxylic acid having three or more carbon atoms.

Another embodiment is a method of inhibiting mold growth on a cementitous material including adding an admixture having an effective amount of a solution of an alkali, alkaline earth or ammonium salt of an alkyl, alkenyl, aryl, alkaryl, or alkenaryl carboxylic acid to inhibit mold growth to a cementitious mixture. Furthermore, one embodiment is a method of inhibiting mold growth on a cementitious material including adding a water soluble alkali, alkaline earth or ammonium salt derived from a carboxylic acid having three or more carbon atoms to a cementitious mixture.

### BRIEF DESCRIPTION OF THE DRAWINGS

The invention may be more completely understood in consideration of the following detailed description of various embodiments in connection with the accompanying drawings, in which:

FIG. 1 is a perspective view of an illustrative cementitious material illustrated as a cinder block; and

FIG. 2 is a perspective view of another illustrative cementitious material illustrated as a revetment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention including cementitious materials used for pavement, structural and other applications.

### DETAILED DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (i.e., having the same function or result). In many instances, the term “about” may be indicative as including numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

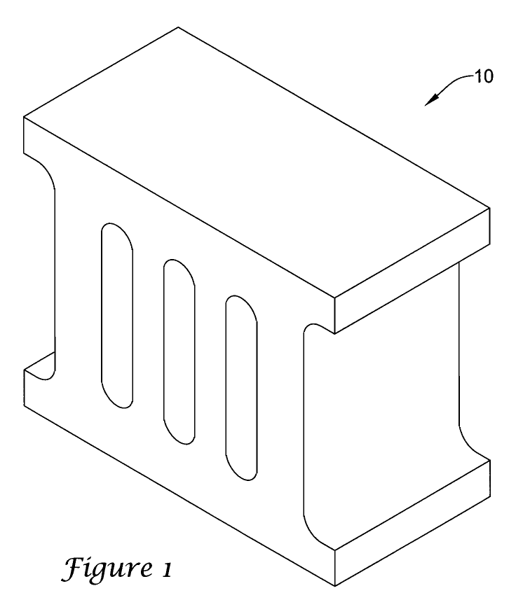

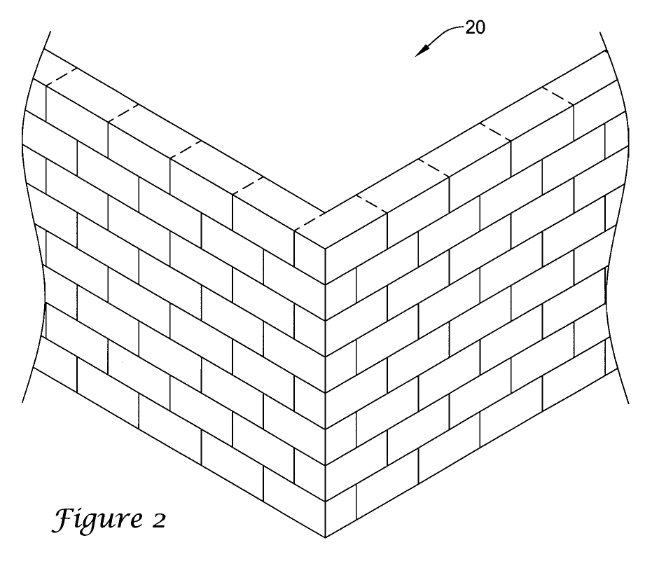

Disclosed is an admixture for use with a cementitious mixture in forming a cementitious material, such as a concrete block, revetment, mortar, grout, or the like, for inhibiting the growth of mold on the surface of the cementitious material. As used herein the term “cementitious material” includes all materials utilizing cement, or similar masonry binding material, as a mixture ingredient. The cementitious material may be a ready-mixed concrete, a precast concrete, concrete masonry or machine-made concrete, concrete pavement or structural elements or other material of a cementitious nature. For example, in some embodiments, the cementitious material may be a concrete block, such as the cinder block 10 illustrated in FIG. 1, or other type of block, such as a landscaping stone, a paving stone, a brick, or the like. Furthermore, in other embodiments, the cementitious material may be a revetment 20 as illustrated in FIG. 2, such as a retaining wall, a basement or foundation wall, or other structural building material. Such a revetment 20 may be constructed by filling a concrete form with a ready-mixed concrete material, or the revetment 20 may be constructed from precast concrete building materials. As shown in FIG. 2, the dashed lines may be indicative of a precast concrete structure. In still other embodiments, the cementitious material may include other cementitious building materials, such as support beams, columns, foundations, motorways/roads, overpasses, or the like.

The cementitious material may be formed from a cementitious mixture. For example, the cementitious mixture may include a cementing material, such as portland cement and/or other binder including fly ash or slag cement, and a mineral aggregate, such as sand, crushed stone, gravel, slag, ashes, burned shale, and/or burned clay, combined with a sufficient amount of water to set and bind the cementitious mixture. Additionally, additives of an organic and/or non-organic nature may be added to the cementitious mixture to provide certain desired characteristics. For example, in some embodiments, an accelerator may be included in the mixture to accelerate the hydration process. Other additives may include, but are not limited to, retarders, air-entrainers, plasticizers, and/or pigments.

The cementitious mixture may include an effective amount of an admixture to inhibit mold growth on the surface of a cementitious material formed of the cementitious mixture. For example, a mold inhibiting admixture may include an alkali, alkaline earth or ammonium salt of alkyl, alkenyl, aryl, alkaryl or alkenaryl carboxylic acids, having three or more carbon atoms, thus excluding formic and acetic acids. The carboxylic acids may have the structural formula as follows wherein R includes two or more carbon atoms:

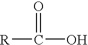

Such carboxylic acids may be capable of forming an alkali, alkaline earth or ammonium salt which may be soluble in water, while manifesting some hydrophobicity opposite the acid group. For example, the admixture may be a sodium, potassium, calcium, magnesium lithium or ammonium salt of a carboxylic acid having three or more carbon atoms. Some examples of carboxylic acids include, but are not limited to, propionic acid (propanoic acid, methylacetic acid), butyric acid (butanoic acid, ethyllacetic acid), isobutyric acid (2-methylpropanoic acid, isopropylformic acid), valeric acid (pentanoic acid, propylacetic acid), phenylacetic acid (-toluic acid), acetylsalicylic acid (aspirin, 2-acetoxybenzoic acid), and levulinic acid (-acetylpropionic acid).

The listed exemplary carboxylic acids may form an alkali, alkaline earth or ammonium salt, such as lithium salts or calcium salts, soluble in water and may be added as a solution to the cementitious mixture. For example, one admixture for inhibiting mold growth on the surface of a cementitious material may be a solution of calcium propionate. Calcium propionate (C₆H₁₀O₄Ca) may be formed by reacting propionic acid (C₃H₆O₂) with calcium hydroxide (Ca(OH)₂). Another example may be a solution of calcium butyrate (Ca(C₄H₇O₂)₂) derived from butyric acid ((C₄H₈O₂). Thus, the admixture may include a calcium salt derived from a carboxylic acid having three or more carbon atoms. Yet another example may be a solution of a lithium salt, which may afford the additional benefit of mitigating potential alkali-silica reactivity in the cementitious mixture. In other embodiments, the admixture may include another alkali, alkaline earth or ammonium salt derived from a carboxylic acid having three or more carbon atoms. An exemplary calcium salt may be formed of anions and cations as follows:

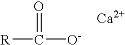

to arrive at a calcium salt as follows:

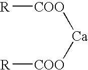

In some embodiments, the mold inhibiting admixture may comprise about 0.05%, or about 0.1% or about 0.2% by weight of the cementitious mixture. For example, in some embodiments, a calcium salt solution, such as calcium propionate or calcium butyrate, may make up about 0.05%, or about 0.1%, or about 0.2% by weight of the ingredients of a cementitious mixture. These percentages are only illustrative, and other quantities of a mold inhibiting calcium salt solution admixture, such as a calcium propionate solution or calcium butyrate solution, may be used as desired. Additionally, other quantities of an admixture which may comprise an alkali, alkaline earth or ammonium salt derived from a carboxylic acid having three or more carbon atoms, may be added to a cementitious mixture in order to inhibit mold growth on the surface of a cementitious material.

In addition to mold inhibition properties added to the cementitious material, the admixture may exhibit additional advantageous characteristics. For example, in some embodiments, the admixture may increase the batch production yield over a conventional cementitious mixture without the admixture, and/or the admixture may provide a slight acceleration of strength development of a cementitious material. Additionally, in some embodiments, the admixture may provide improved pigment uniformity in a cementitious material. Other benefits, such as water reduction and increased plasticizing, thus increased workability, of a cementitious mixture may be realized in some embodiments.

### EXAMPLE 1

One example utilized a series of calcium propionate solutions comprising 0.05, 0.1, and 0.2% by weight of concrete ingredients added during commercial production of concrete revetment pieces. The control concrete mixture used, which was the same as that used for typical concrete block production, is shown in Table 1.

TABLE 1

| | | |
|---|---|---|
| ⅜″ Coarse Aggregate | 1049 | lbs. |
| ¼″ to ⅛″ Coarse Aggregate | 700 | lbs. |
| Concrete Sand | 1749 | lbs. |
| Cement (Type I) | 320 | lbs. |
| Fly Ash (Class C) | 104 | lbs. |
| Slag Cement | 50 | lbs. |
| Water | 189 | lbs. |
| Accelerator (CaCl₂) | 0.42 | lbs |

In the series of concrete mixtures including solutions of calcium propionate, selected quantities of calcium propionate (C₆H₁₀O₄Ca) were substituted for the accelerator (CaCl₂) as indicated. Additionally, as indicated by the water-to-cementitious ration (w/c ratio), the water was reduced to maintain concrete consistency for processing. The results are shown in Table 2.

TABLE 2

| Property | Control | 0.2% | 0.1% | 0.05% |
|---|---|---|---|---|
| Addition (%)¹ | — | 1.68 | 0.84 | 0.42 |
| w/c Ratio | 0.397 | 0.391² | 0.377 | 0.366 |
| Unit Weight (lbs/ft2) | 140.6 | 139.5 | 141.4 | 141.6 |
| Production (pieces) | 198 | 204 | 207 | 210 |
| Sequence | 1 | 2 | 3 | 4 |
| Compressive Strength (psi) | 1801 | 1817 | 1949 | 2175 |

¹Admixture addition expressed as % of total cementitious material by weight.
²No water adjustment was made for the 0.2%.

As shown in Table 2, a reduction in the w/c (water-cementitious) ratio and an increase in unit weight with an increase in production output was evidenced with the series of concrete mixtures including the select quantities of calcium propionate. Furthermore, the reduction in w/c ratio and the increase in unit weight suggests an increased efficiency in cement hydration of the concrete mixtures including the select quantities of calcium propionate.

Samples of cementitious materials formed from a cementitious mixture including the calcium propionate solutions were inoculated with a composition of mold and placed in an environment conducive of mold growth. After two weeks in the environment, no mold propagation was observed on the cementitious materials formed from cementitious mixtures comprising various volumes of calcium propionate solution.

### EXAMPLE 2

A second example included the addition of a calcium propionate solution at 0.2% of total concrete material added to a pigmented art concrete mixture to arrive at the cementitious mixture illustrated in Table 3.

TABLE 3

| | |
|---|---|
| Cement (Type I) | 470 lbs. |
| Water | 267 lbs. |
| Calcium Propionate | 4.6 lbs. |
| Pumice Aggregate Blend | 1472 lbs. |

A cementitious mixture wherein a known accelerator admixture was substituted for the calcium propionate admixture was used as a control mixture. The art concrete pieces produced with the calcium propionate admixture yielded products with a more uniformly dispersed pigmentation than those generated using the accelerator admixture of the control mixture. Additionally, the average compressive strength of the pieces formed with the calcium propionate admixture were 2510 psi, and the average compressive strength of the pieces formed with the control mixture were 2395 psi. Thus, the average compressive strength of the pieces formed with the calcium propionate admixture were about 5% greater than those pieces formed with the control mixture. The corresponding 28-day strength results were 2780 psi for the mixture including the calcium propionate admixture, and 2665 psi for the control mixture. Furthermore, results of water absorption testing on 7-day old pieces of each mixture indicated an average water uptake of 4.7% in the pieces including calcium propionate and 10.4% in the pieces formed from the control mixture, indicating that the calcium propionate provides significant inhibition of water uptake.

Those skilled in the art will recognize that the present invention may be manifested in a variety of forms other than the specific embodiments described and contemplated herein. Accordingly, departure in form and detail may be made without departing from the scope and spirit of the present invention as described in the appended claims.

What is claimed is:

1. A cementitious material having mold inhibiting properties, the cementitious material comprising:
a cementitious mixture; and
an admixture including a water soluble alkali, alkaline earth or ammonium salt derived from a carboxylic acid, the carboxylic acid having three or more carbon atoms.

2. The cementitious material of claim 1, wherein the carboxylic acid is propionic acid.

3. The cementitious material of claim 1, wherein the carboxylic acid is butyric acid.

4. The cementitious material of claim 1, wherein the carboxylic acid is isobutyric acid.

5. The cementitious material of claim 1, wherein the carboxylic acid is valeric acid.

6. The cementitious material of claim 1, wherein the carboxylic acid is isovaleric acid.

7. The cementitious material of claim 1, wherein the carboxylic acid is benzoic acid.

8. The cementitious material of claim 1, wherein the carboxylic acid is phenylacetic acid.

9. The cementitious material of claim 1, wherein the carboxylic acid is acetylsalicylic acid.

10. The cementitious material of claim 1, wherein the carboxylic acid is levulinic acid.

11. The cementitious material of claim 1, wherein the alkali or alkaline earth salt is a sodium salt.

12. The cementitious material of claim 1, wherein the alkali or alkaline earth salt is a potassium salt.

13. The cementitious material of claim 1, wherein the alkali or alkaline earth salt is a magnesium salt.

14. The cementitious material of claim 1, wherein the alkali or alkaline earth salt is a lithium salt.

15. The cementitious material of claim 1, wherein the alkali or alkaline earth salt is a calcium salt.

16. The cementitious material of claim 1, wherein the alkaline earth salt is an ammonium salt.

17. The cementitious material of claim 15, wherein the calcium salt is calcium propionate.

18. The cementitious material of claim 1, wherein the cementitious material is a cementitious building material.

19. The cementitious material of claim 18, wherein the cementitious building material is a cement block.

20. The cementitious material of claim 18, wherein the cementitious building material is a revetment.

21. The cementitious material of claim 18, wherein the cementitious material is pavement or structural concrete.

22. A cementitious material having mold inhibiting properties, the cementitious material comprising:
a cementitious mixture; and
an admixture including a means for inhibiting mold growth on the surface of the cementitious material.

23. The cementitious material of claim 22, wherein the means for inhibiting mold growth includes a solution of an alkali salt.

24. The cementitious material of claim 24, wherein the solution of an alkali salt is derived from a carboxylic acid.

25. The cementitious material of claim 25, wherein the carboxylic acid includes three or more carbon atoms.

26. The cementitious material of claim 25, wherein the carboxylic acid is selected from the group consisting of propionic acid, butyric acid, isobutyric acid, isobutyric acid, valeric acid, isovaleric acid, benzoic acid, phenylacetic acid, acetylsalicylic acid, and levulinic acid.

27. The cementitious material of claim 22, wherein the means for inhibiting mold growth includes a solution of an alkaline earth salt.

28. The cementitious material of claim 27, wherein the solution of an alkaline earth salt is derived from a carboxylic acid.

29. The cementitious material of claim 28, wherein the carboxylic acid includes three or more carbon atoms.

30. The cementitious material of claim 29, wherein the carboxylic acid is selected from the group consisting of propionic acid, butyric acid, isobutyric acid, isobutyric acid, valeric acid, isovaleric acid, benzoic acid, phenylacetic acid, acetylsalicylic acid, and levulinic acid.

31. The cementitious material of claim 22, wherein the means for inhibiting mold growth includes a solution of an ammonium salt.

32. The cementitious material of claim 31, wherein the solution of an ammonium salt is derived from a carboxylic acid.

33. The cementitious material of claim 28, wherein the carboxylic acid includes three or more carbon atoms.

34. The cementitious material of claim 29, wherein the carboxylic acid is selected from the group consisting of propionic acid, butyric acid, isobutyric acid, isobutyric acid, valeric acid, isovaleric acid, benzoic acid, phenylacetic acid, acetylsalicylic acid, and levulinic acid.

35. A cementitious material having mold inhibiting properties, the cementitious material comprising:
a cementitious mixture including an effective amount of a solution of an alkali, alkaline earth or ammonium salt of an alkyl, alkenyl, aryl, alkaryl, or alkenaryl carboxylic acid to inhibit mold growth.

36. The cementitious material of claim 35, wherein the carboxylic acid is selected from the group consisting of propionic acid, butyric acid, isobutyric acid, isobutyric acid, valeric acid, isovaleric acid, benzoic acid, phenylacetic acid, acetylsalicylic acid, and levulinic acid.

37. The cementitious material of claim 35, wherein the alkali, alkaline earth or ammonium salt is selected from the group consisting of a sodium salt, a potassium salt, a magnesium salt, a lithium salt, a calcium salt and an ammonium salt.

38. The cementitious material of claim 35, wherein the alkali, alkaline earth or ammonium salt is calcium propionate.

39. A method of inhibiting mold growth on a cementitious material, the method comprising the steps of:
providing a cementitious mixture;
adding an admixture to the cementitious mixture, wherein the admixture includes a water soluble alkali, alkaline earth or ammonium salt derived from a carboxylic acid, the carboxylic acid having three or more carbon atoms; and
forming a cementitious material with the cementitious mixture.

40. The method of claim 39, wherein the carboxylic acid is propionic acid.

41. The method of claim 39, wherein the carboxylic acid is butyric acid.

42. The method of claim 39, wherein the carboxylic acid is isobutyric acid.

43. The method of claim 39, wherein the carboxylic acid is valeric acid.

44. The method of claim 39, wherein the carboxylic acid is isovaleric acid.

45. The method of claim 39, wherein the carboxylic acid is benzoic acid.

46. The method of claim 39, wherein the carboxylic acid is phenylacetic acid.

47. The method of claim 39, wherein the carboxylic acid is acetylsalicylic acid.

48. The method of claim 39, wherein the carboxylic acid is levulinic acid.

49. The method of claim 39, wherein the alkali, alkaline earth or ammonium salt is a sodium salt.

50. The method of claim 39, wherein the alkali, alkaline earth or ammonium salt is a potassium salt.

51. The method of claim 39, wherein the alkali, alkaline earth or ammonium salt is a magnesium salt.

52. The method of claim 39, wherein the alkali, alkaline earth or ammonium salt is a lithium salt.

53. The method of claim 39, wherein the alkali, alkaline earth or ammonium salt is a calcium salt.

54. The method of claim 39, wherein the alkali, alkaline earth or ammonium salt is an ammonium salt.

55. The method of claim 39, wherein the calcium salt is calcium propionate.

56. The method of claim 39, wherein the cementitious material is a cementitious building material.

57. The method of claim 39, wherein the cementitious building material is a concrete block.

58. The method of claim 39, wherein the cementitious building material is a revetment.

59. The method of claim 39, wherein the cementitious material is a cementitious pavement or structural concrete.

60. A method of inhibiting mold growth on a cementitious material, the method comprising the steps of:
providing a cementitious mixture;
adding an admixture including a means for inhibiting mold growth on the surface of the cementitious mixture; and
forming a cementitious material with the cementitious mixture.

61. The method of claim 60, wherein the means for inhibiting mold growth includes a solution of an alkali salt.

62. The method of claim 61, wherein the solution of an alkali salt is derived from a carboxylic acid.

63. The method of claim 62, wherein the carboxylic acid includes three or more carbon atoms.

64. The method of claim 63, wherein the carboxylic acid is selected from the group consisting of propionic acid, butyric acid, isobutyric acid, isobutyric acid, valeric acid, isovaleric acid, benzoic acid, phenylacetic acid, acetylsalicylic acid, and levulinic acid.

65. The method of claim 60, wherein the means for inhibiting mold growth includes a solution of an alkaline earth salt.

66. The method of claim 65, wherein the solution of an alkaline earth salt is derived from a carboxylic acid.

67. The method of claim 66, wherein the carboxylic acid includes three or more carbon atoms.

68. The method of claim 67, wherein the carboxylic acid is selected from the group consisting of propionic acid, butyric acid, isobutyric acid, isobutyric acid, valeric acid, isovaleric acid, benzoic acid, phenylacetic acid, acetylsalicylic acid, and levulinic acid.

69. The method of claim 60, wherein the means for inhibiting mold growth includes a solution of an ammonium salt.

70. The method of claim 61, wherein the solution of an ammonium salt is derived from a carboxylic acid.

71. The method of claim 62, wherein the carboxylic acid includes three or more carbon atoms.

72. The method of claim 63, wherein the carboxylic acid is selected from the group consisting of propionic acid, butyric acid, isobutyric acid, isobutyric acid, valeric acid, isovaleric acid, benzoic acid, phenylacetic acid, acetylsalicylic acid, and levulinic acid.

73. A method of inhibiting mold growth on a cementitious material, the method comprising the steps of:
providing a cementitious mixture;
adding an effective amount of a solution of an alkali, alkaline earth or ammonium salt of an alkyl, alkenyl, aryl, alkaryl, or alkenaryl carboxylic acid to inhibit mold growth to the cementitious mixture; and
forming a cementitious material with the cementitious mixture.

74. The method of claim 73, wherein the carboxylic acid is selected from the group consisting of propionic acid, butyric acid, isobutyric acid, isobutyric acid, valeric acid, isovaleric acid, benzoic acid, phenylacetic acid, acetylsalicylic acid, and levulinic acid.

75. The method of claim 73, wherein the alkali, alkaline earth or ammonium salt is selected from the group consisting of a sodium salt, a potassium salt, a magnesium salt, a lithium salt, a calcium salt and an ammonium salt.

76. The method of claim 73, wherein the alkali, alkaline earth or ammonium salt is calcium propionate.
